(19) United States
(12) Patent Application Publication
(10) Pub. No.: US 2024/0411961 A1
(43) Pub. Date: Dec. 12, 2024

(54) SYSTEM AND METHOD FOR IMPLEMENTING A DATA-DRIVEN FRAMEWORK FOR OBSERVATION, DATA ASSIMILATION, AND PREDICTION OF OCEAN CURRENTS

(71) Applicant: Xerox Corporation, Norwalk, CT (US)

(72) Inventors: Ashesh Kumar Chattopadhyay, Mountain View, CA (US); Kalaivani Ramea Kubendran, Fremont, CA (US); Eric David Cocker, Redwood City, CA (US)

(73) Assignee: Xerox Corporation, Norwalk, CT (US)

(21) Appl. No.: 18/206,767

(22) Filed: Jun. 7, 2023

(51) Int. Cl. G06F 30/27

(52) U.S. Cl. CPC G06F 30/27; G06F 2111/08

(57) ABSTRACT

A framework is provided where a stochastic fully data-driven model (FDDM) predicts states of the ocean for both short and long-time scales with uncertainty quantification. The FDDM, which can generate a large number of ensembles at low computational cost, is integrated with a multi-layer perceptron-based data assimilation algorithm, which can efficiently and accurately assimilate Lagrangian ocean observations.

### BACKGROUND

Modeling and forecasting the atmosphere and oceans of Earth are daunting tasks that require resolving chaotic physical processes that cover a broad range of spatio-temporal scales. State-of-the-art (SOTA) Earth system models (ESM) are typically comprised of computationally expensive numerical algorithms that solve the coupled governing dynamics of the several physical processes affecting climate. Most operational ESMs cannot resolve all the physical processes, owing to limited computational resources, and resort to low-resolution modeling, wherein many of the small-scale physical processes are approximated in a semi-empirical or ad-hoc manner. These models are then reinforced with data assimilation (DA), wherein sparse and noisy observations of some of these physical processes (e.g., temperature at certain vertical levels, ocean-surface currents, etc.) are used to correct the state of the Earth system with which the numerical models can perform short-term forecasting and compute long-term statistics.

The major drawback in ESMs, in terms of practical use, is the enormous computational cost that is incurred to obtain forecasts. Moreover, since these models approximate the small-scale physical processes, e.g., convection, probabilistic forecasts are needed to accurately quantify the uncertainty contributed by these approximations. This further adds to the computational cost, since a large number of ensembles of forecasts for uncertainty quantification is required.

Moreover, most common DA algorithms that are used to correct the states obtained from these ESMs have two major drawbacks: (a) similar to probabilistic forecasting, they also require a large number of ensembles of forecasts to compute an accurate background covariance structure and (b) for ocean processes, the observations that are available are Lagrangian in nature, i.e., their locations drift over time. As such, most algorithms employ ad-hoc strategies to perform DA, contributing to inaccuracies in the estimated state and thus future forecasts.

### BRIEF DESCRIPTION

In accordance with one aspect of the presently described embodiments, a system comprises at least one processor and at least one memory having instructions stored thereon that, when executed by the at least one processor, cause the processor at least to generate data ensembles using a stochastic data driven prediction model trained on ocean simulations, receive observation data, estimate an analysis state using a multi-layer perceptron that represents the analysis state as a non-linear conjunction of observations and minimizing variance across the ensembles and selectively output a prediction on ocean conditions.

In another aspect of the presently described embodiments, the analysis state is used as an initial condition to perform forecasting or generate the ensembles for a next cycle.

In another aspect of the presently described embodiments, the stochastic data drive prediction model comprises a fully data driven model which is a stochastic variational model or a variational autoencoder configured to predict a large number of ensembles of states of the ocean.

In another aspect of the presently described embodiments, the fully data driven model comprises a 4th order Runge Kutta (RK4) based time-integrator for accurate estimation of future time steps with low error growths.

In another aspect of the presently described embodiments, the fully data driven model is configured to add physical constraints within its architecture or through regularization.

In another aspect of the presently described embodiments, the fully data driven model is configured to perform robust uncertainty quantification through the statistics obtained from the large ensembles.

In another aspect of the presently described embodiments, the multi-layer perceptron is configured to perform a Lagrangian data assimilation method capable of integrating distributed sensor observations from the ocean.

In another aspect of the presently described embodiments, the multi-layer perceptron is non-linear and free of ad-hoc choices in de-correlation lengths.

In another aspect of the presently described embodiments, the multi-layer perceptron is implemented on the same device as the fully data driven model allowing for on-the-fly data assimilation without expensive data transfer.

In another aspect of the presently described embodiments, a method comprises generating data ensembles using a stochastic data driven prediction model trained on ocean simulations, receiving observation data, estimating an analysis state using a multi-layer perceptron that represents the analysis state as a non-linear conjunction of observations and minimizing variance across the ensembles and selectively outputting a prediction on ocean conditions.

In another aspect of the presently described embodiments, the analysis state is used as an initial condition to perform forecasting or generate the ensembles for a next cycle.

In another aspect of the presently described embodiments, the stochastic data drive prediction model comprises a fully data driven model which is a stochastic variational model or a variational autoencoder configured to predict a large number of ensembles of states of the ocean at low computational cost.

In another aspect of the presently described embodiments, the fully data driven model comprises a 4th order Runge Kutta (RK4) based time-integrator for accurate estimation of future time steps with low error growths.

In another aspect of the presently described embodiments, the fully data driven model is configured to add physical constraints within its architecture or through regularization.

In another aspect of the presently described embodiments, the fully data driven model is configured to perform robust uncertainty quantification through the statistics obtained from the large ensembles.

In another aspect of the presently described embodiments, the multi-layer perceptron is configured to perform a Lagrangian data assimilation method capable of integrating distributed sensor observations from the ocean.

In another aspect of the presently described embodiments, the multi-layer perceptron is non-linear and free of ad-hoc choices in de-correlation lengths.

In another aspect of the presently described embodiments, the multi-layer perceptron is implemented on the same device as the fully data driven model allowing for on-the-fly data assimilation.

In another aspect of the presently described embodiments, a non-transitory computer readable medium having stored thereon instructions that, when executed by a processor, cause a system to generate data ensembles using a stochastic data driven prediction model trained on ocean simulations, receive observation data, estimate an analysis state using a multi-layer perceptron that represents the analysis state as a non-linear conjunction of observations and minimizing variance across the ensembles and selectively output a prediction on ocean conditions.

In another aspect of the presently described embodiments, the analysis state is used as an initial condition to perform forecasting or generate the ensembles for a next cycle.

### BRIEF DESCRIPTION OF THE DRAWINGS

FIG. 1 illustrates an example schematic diagram of a system according to the presently described embodiments;

FIG. 2 illustrates a flow diagram according to the presently described embodiments;

FIG. 3 illustrates a flow chart of an example method according to the presently described embodiments;

FIGS. 4A and 4B illustrate example outputs of various systems;

FIGS. 5A-5C illustrate data results comparisons; and,

FIG. 6 is a system according to the presently described embodiments.

### DETAILED DESCRIPTION

The presently described embodiments, in at least one form, relate to a data-driven framework for observation, data assimilation and prediction (also referred to as ODAP) of ocean currents. The framework according to the presently described embodiments, in at least one form, integrates a stochastic data-driven prediction module, based on a conditional β-variational autoencoder (β-VAE) and a multi-layer perceptron (MLP)-based Lagrangian data assimilation (DA) algorithm to efficiently and accurately predict ocean-surface currents. In at least one implementation, the framework includes: (a) a stochastic data-driven prediction module, trained on ocean simulations, that can generate a large number of ensembles of short-term forecasts at low computational cost and (b) a MLP-based DA algorithm that can assimilate Lagrangian ocean observations using the ensemble of data-driven forecasts, to estimate an accurate analysis state that can be used for forecasting future ocean currents. The long-term stability of the data-driven model allows one to estimate long-term trajectories of passive tracers, such as harmful algae bloom (e.g., with uncertainty quantification) and predict extreme events, e.g., rogue waves.

According to the presently described embodiments, a computationally inexpensive, data-driven rigorous solution is provided, to perform forecasting over global or regional ocean bodies. While the presently described embodiments are described in the context of oceans, the approach is general and can be applied to both the atmospheric and oceanic component in an ESM.

In at least one form, the presently described embodiments are implemented in a framework for integrating Lagrangian observations, and subsequently short- and long-term predictions of the oceanic states, in a purely data-driven fashion. In this regard, in at least one form, the presently described embodiments have at least two components or portions:
FDDM: A fully data-driven model (e.g., FDDM) for short- and long-term predictions. In at least one form, a stochastic conditional β-VAE equipped with a higher-order RK4-based integrator is implemented. This model is trained on several years of ocean simulations from the Navy Coastal Ocean Model (NCOM). The trained FDDM then evolves the state of the ocean through autoregressive inference. Owing to the variational nature of the FDDM, it can generate a large ensemble of predictions at every time step in a computationally inexpensive fashion.
MLP-based DA: The predicted large ensemble of states is then used by an MLP to formulate, in at least one form, an ensemble optimal interpolation (EnOI)-based DA algorithm to compute the analysis state from Lagrangian ocean observations of surface currents.

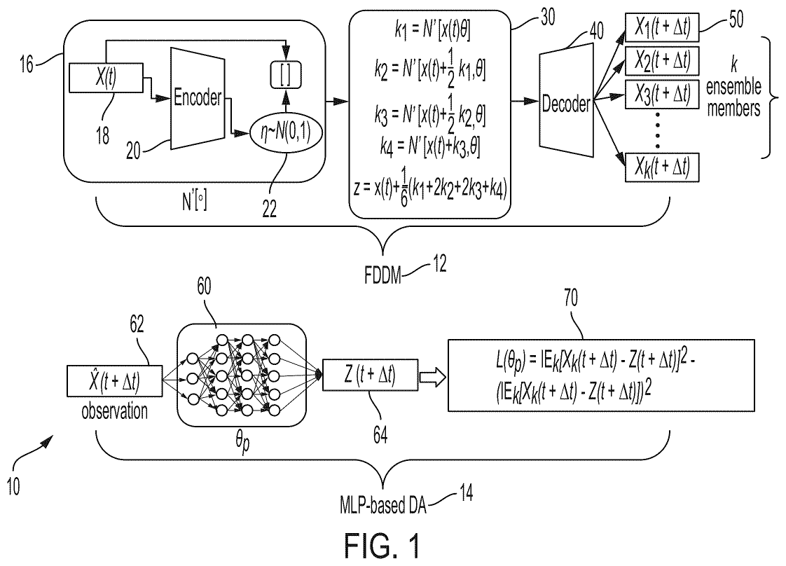

With reference to FIG. 1, a schematic diagram of the ODAP framework 10, highlighting both noted components, an FDDM 12 and MLP-based DA 14, is shown. More particularly, the example framework 10 includes an FDDM 12. The example FDDM 12 shown includes an encoder portion 16 having an input initial state 18, encoder 20 and output 22. The FDDM may take a variety of forms but, in at least one form, the FDDM is a stochastic variational model or a variational autoencoder configured to predict a large number of ensembles of states of the ocean. Also shown is an integrator 30. The integrator may take a variety of forms, but in at least one form it is implemented as a 4th order Runge Kutta based, or an RK4 based, time-integrator—to achieve, for example, accurate estimation of future time steps with low error growths. A decoder 40, which may also take a variety of forms, is also shown as well as the ensemble of predictions 50 generated according to the presently described embodiments. In at least one form, the FDDM 12 is configured to add physical constraints within its architecture or through regularization and/or configured to perform robust uncertainty quantification through the statistics obtained from the large ensembles.

The example MLP-based DA 14 includes a multi-layer perceptron (MLP) 60 having θₚ parameters that represents the analysis state as a nonlinear combination of the observations. In at least one of the various possible forms, the multi-layer perceptron is configured to perform a Lagrangian data assimilation method capable of integrating distributed sensor observations from the ocean. Further, the multi-layer perceptron is non-linear and free of ad-hoc choices in de-correlation lengths, as is common in traditional data assimilation algorithm. Also, in at least one form, the multi-layer perceptron is implemented on the same device as the fully data driven model allowing for on-the-fly data assimilation without expensive data transfer.

With continued reference to FIG. 1, the MLP 60 has an input of at least one ocean observation 62 (e.g., Lagrangian ocean observations of surface currents) and an output of an analysis state 64. It should be appreciated that the output analysis state 64 can have a variety of uses or applications, including as a further iterative parameter for further generation of data ensembles or as a basis for forecasting or prediction, as shown, at 70. At least one advantage of the ODAP framework over traditional prediction and DA frameworks is that, both the prediction and DA module can be executed on a GPU under constrained computational resources.

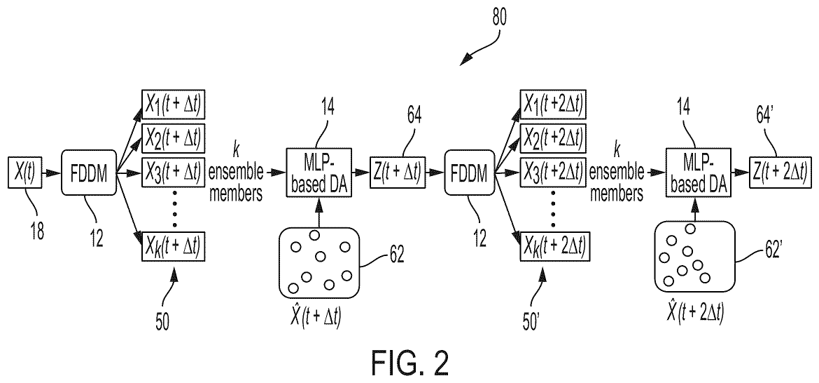

Referring now to FIG. 2, an example operational flow 80 of the ODAP framework is illustrated. In such an implementation, the FDDM 12 is trained on NCOM simulations, as mentioned. In at least one form, the FDDM 12 is initialized with state 18, X(t), on the model grid, at time, t. Again, in at least one form, the FDDM 12 predicts k ensemble members 50 of the future state of the ocean at time, t+Δt, given by X₁(t+Δt), X₂(t+2Δt), X₃(t+3Δt), . . . . Xₖ(t+Δt). At this point, the system 10 receives an observation 62 from the ocean, \hat{X}(t) (t), which is not defined on the model grid. In at least one form, in order to estimate an analysis state 64, Z(t+Δt), on the model grid, a configuration 14 is implemented using an MLP 60 with Op parameters that represents the analysis state as a nonlinear combination of the observations and minimizes the variance across the predicted ensembles. Once this analysis state 64, Z(t+Δt), is obtained, for example, one can use this as a more accurate initial condition to perform forecasting or generate the ensembles 50′ for the next DA cycle that will generate analysis stat 64′. Of course, the number of iterations may vary depending on the implementation of the presently described embodiments.

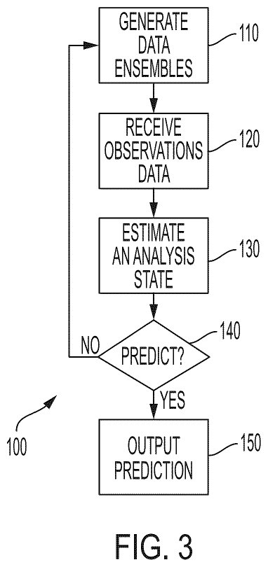

Also, it should be appreciated that methods according to the presently described embodiments implementing the techniques described herein could take a variety of forms and be implemented on a variety of systems using various software techniques and hardware configurations. With reference to FIG. 3, an example method 100 is shown in the illustrated flowchart. The method 100 comprises generating data ensembles (at 110). In at least one form, this includes generating a large number of ensembles of short-term forecasts of ocean surface currents at low computational cost using an FDDM, as described. Next, the system or framework receives observation data (at 120) which, in at least one form, includes an observation from the ocean. These data ensembles and the observation are then used to estimate an analysis state (at 130) using, in one example form, an MLP-based data assimilation technique, as described. A determination is then made as to whether the analysis state will be used to output a prediction (at 140). If not, the analysis state is used to generate another iteration of data ensembles. However, if a prediction is made, the prediction is output (at 150). It should be appreciated that the output contemplated herein may include a variety of different output or output formats to a variety of different systems that will make use of the analysis states, predictions and/or forecasting of the presently described embodiments.

In one implementation of the presently described embodiments, a conditional β-VAE model is trained on surface-u (zonal), and v (meridional) currents from 10 years of NCOM ocean simulations over the Gulf of Mexico region. Each u and v snapshots are 3 hours apart. Surface current observations used may originate from or be generated by a variety of reliable sources. In one example, 240 DA cycles were run over 30 days and used the analysis state for forecasting.

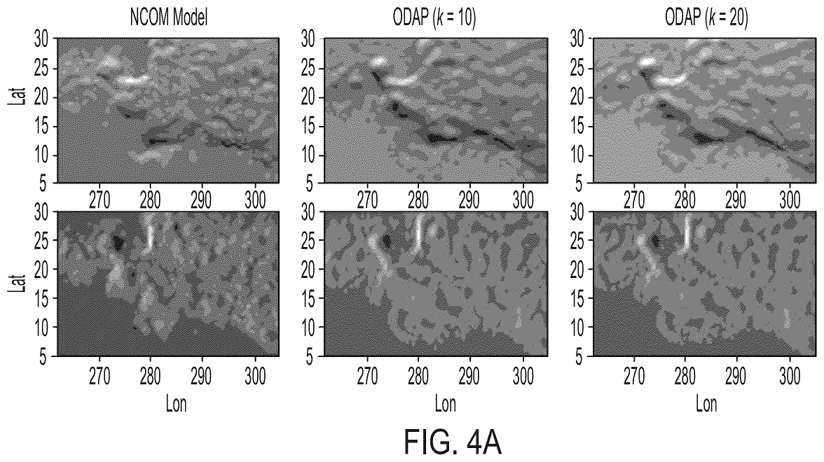

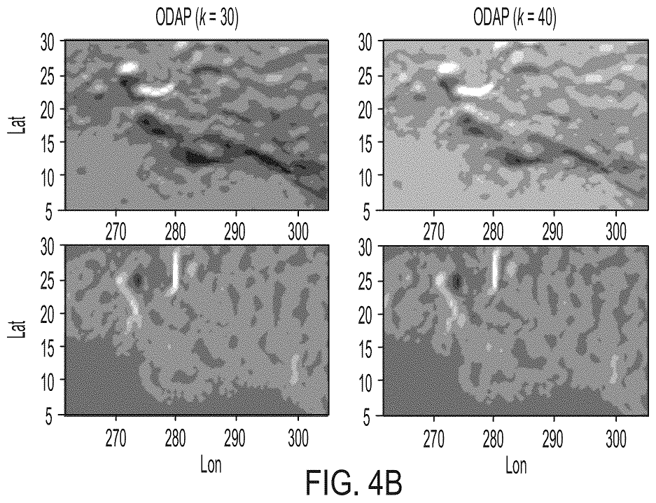

FIGS. 4A and 4B show several ensembles of forecasts at 12 days. The ensembles show low uncertainty in the background flow, but high uncertainty in the anomalies. FIGS. 4A and 4B illustrate that the presently described embodiments, e.g., different implementations of ODAP, are as accurate as the numerical NCOM model at orders of magnitude low computational cost. In this regard, FIGS. 4A and 4B show predictions from the FDDM model. The upper row of FIGS. 4A and 4B shows horizontal velocity for the NCOM model and ODAP ensemble members k=10, 20, 30, and 40. The lower row of FIGS. 4A and 4B shows vertical velocity for the NCOM model and ODAP ensemble members k=10, 20, 30, and 40. That is, each of the pairs of panels upper and lower, upper for horizontal velocity and lower for vertical velocity, are example members of prediction from the model (e.g., k=10, is the 10th ensemble member), except for the first upper and lower panels of FIG. 4A which are the prediction from what is currently state-of-the-art in the industry, i.e., NCOM. The fact that they look similar is evidence that the presently described embodiments of the proposed FDDM model works just as well as a conventional technique. However, the presently described embodiments are orders of magnitude faster and cheaper to execute.

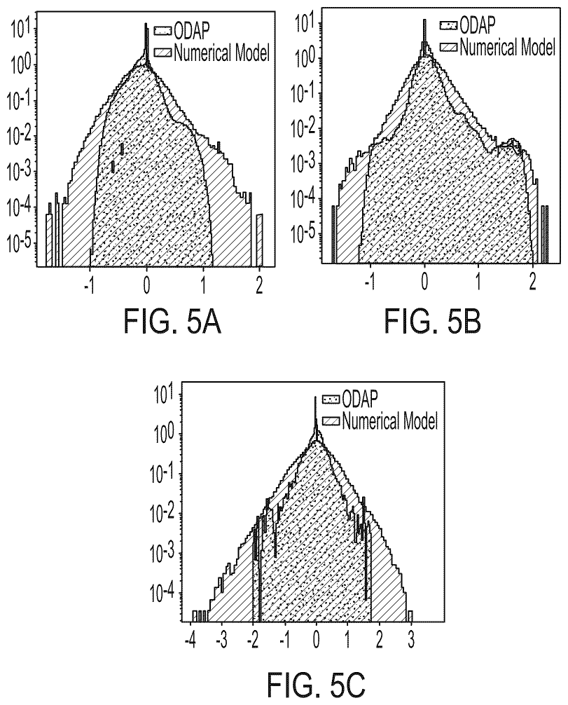

Further FIG. 5A shows the probability density function (PDF) of u in Gulf of Mexico region over 12 days. Similarly, FIG. 5B shows the PDF of the meridional velocity, wherein the structure of the PDF is better captured as compared to the zonal velocity. Also computed is the PDF of vorticity (ω), where, ω=∂v/∂x−∂u/∂y, in FIG. 5C. The illustrated probability density functions show that implementation of the presently described embodiments significantly improves the predictability outcome, e.g., results in a greater likelihood that the actual oceanic events will fall within more precise predicted ranges.

The presently described embodiments provide a variety of advantages. For example, they help solving the problem of short- and long-term forecasts of regional ocean at low computational cost using a data-driven framework. Low computational cost solutions are more amenable to be deployed under resource-constrained settings, e.g., onboard sensor, etc., where large servers for training and executing models may not be possible. The presently described embodiments also provide on-the-fly data assimilation of Lagrangian observations at low computational cost with a data-driven framework which can be used for forecasting. Further, capability to predict of multi-year-scale statistics in ocean dynamics, e.g., distribution of extreme events, changes in the geochemical cycle due to climate change, etc., is improved over current techniques.

As alluded to above, the state-of-the-art in numerical ocean forecasting and data assimilation is computationally taxing and often ad-hoc, relying on semi-empirical schemes, as well as expensive. The presently described embodiments address these problems through a data-driven framework for prediction and data assimilation using deep learning.

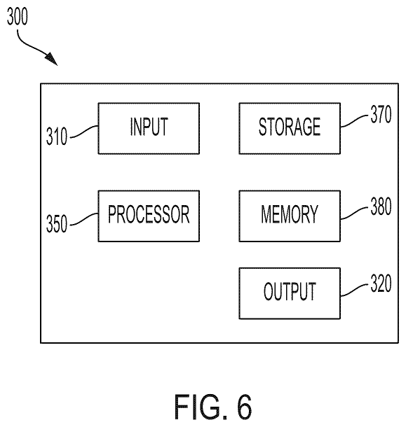

With reference now to FIG. 6, the above-described method 100 and other methods according to the presently described embodiments, as well as suitable architecture such as system components useful to implement the framework or system 10 shown in FIG. 1 and in connection with other embodiments described herein can be implemented on a computer using well-known computer processors, memory units, storage devices, computer software, and other components. A high-level block diagram of such a computer is illustrated in FIG. 6. Computer 300 contains at least one processor 350, which controls the overall operation of the computer 300 by executing computer program instructions which define such operation. The computer program instructions may be stored in at least one storage device or memory 380 (e.g., a magnetic disk or any other suitable non-transitory computer readable medium or memory device) and loaded into another memory 380 (e.g., a magnetic disk or any other suitable non-transitory computer readable medium or memory device), or another segment of memory 370, when execution of the computer program instructions is desired. Thus, the steps of the methods described herein may be defined by the computer program instructions stored in the memory 380 and controlled by the processor 350 executing the computer program instructions. The computer 300 may include one or more input elements 310 and output elements 320 for communicating with other devices via a network. The output elements may include a variety of different interfaces to a variety of different systems that will make use of the analysis states, predictions and/or forecasting of the presently described embodiments. The computer 300 also includes a user interface that enables user interaction with the computer 300. The user interface may include I/O devices (e.g., keyboard, mouse, speakers, buttons, etc.) to allow the user to interact with the computer.

According to various embodiments, as referred to above, FIG. 6 is a high-level representation of possible components of a computer for illustrative purposes and the computer may contain other components. Also, the computer 300 is illustrated as a single device or system. However, the computer 300 may be implemented as more than one device or system and, in some forms, may be a distributed system with components or functions suitably distributed in, for example, a network or in various locations.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A system comprising:
at least one processor; and,
at least one memory having instructions stored thereon that, when executed by the at least one processor, cause the processor at least to:
generate data ensembles using a stochastic data driven prediction model trained on ocean simulations;
receive observation data;
estimate an analysis state using a multi-layer perceptron that represents the analysis state as a non-linear conjunction of observations and minimizing variance across the ensembles; and
selectively output a prediction on ocean conditions.

2. The system as set forth in claim 1, wherein the analysis state is used as an initial condition to perform forecasting or generate the ensembles for a next cycle.

3. The system as set forth in claim 1, wherein the stochastic data drive prediction model comprises a fully data driven model which is a stochastic variational model or a variational autoencoder configured to predict a large number of ensembles of states of the ocean.

4. The system as set forth in claim 3, wherein the fully data driven model comprises a 4th order Runge Kutta (RK4) based time-integrator for accurate estimation of future time steps with low error growths.

5. The system as set forth in claim 3, wherein the fully data driven model is configured to add physical constraints within its architecture or through regularization.

6. The system as set forth in claim 3, wherein the fully data driven model is configured to perform robust uncertainty quantification through the statistics obtained from the large ensembles.

7. The system as set forth in claim 1, wherein the multi-layer perceptron is configured to perform a Lagrangian data assimilation method capable of integrating distributed sensor observations from the ocean.

8. The system as set forth in claim 7, wherein the multi-layer perceptron is non-linear and free of ad-hoc choices in de-correlation lengths.

9. The system as set forth in claim 7, wherein the multi-layer perceptron is implemented on the same device as the fully data driven model allowing for on-the-fly data assimilation.

10. A method comprising:
generating data ensembles using a stochastic data driven prediction model trained on ocean simulations;
receiving observation data;
estimating an analysis state using a multi-layer perceptron that represents the analysis state as a non-linear conjunction of observations and minimizing variance across the ensembles; and
selectively outputting a prediction on ocean conditions.

11. The method as set forth in claim 10, wherein the analysis state is used as an initial condition to perform forecasting or generate the ensembles for a next cycle.

12. The method as set forth in claim 10, wherein the stochastic data drive prediction model comprises a fully data driven model which is a stochastic variational model or a variational autoencoder configured to predict a large number of ensembles of states of the ocean at low computational cost.

13. The method as set forth in claim 10, wherein the fully data driven model comprises a 4th order Runge Kutta (RK4) based time-integrator for accurate estimation of future time steps with low error growths.

14. The system as set forth in claim 11, wherein the fully data driven model is configured to add physical constraints within its architecture or through regularization.

15. The system as set forth in claim 11, wherein the fully data driven model is configured to perform robust uncertainty quantification through the statistics obtained from the large ensembles.

16. The system as set forth in claim 10, wherein the multi-layer perceptron is configured to perform a Lagrangian data assimilation method capable of integrating distributed sensor observations from the ocean.

17. The system as set forth in claim 16, wherein the multi-layer perceptron is non-linear and free of ad-hoc choices in de-correlation lengths.

18. The system as set forth in claim 16, wherein the multi-layer perceptron is implemented on the same device as the fully data driven model allowing for on-the-fly data assimilation.

19. A non-transitory computer readable medium having stored thereon instructions that, when executed by a processor, cause a system to:
generate data ensembles using a stochastic data driven prediction model trained on ocean simulations;
receive observation data;
estimate an analysis state using a multi-layer perceptron that represents the analysis state as a non-linear conjunction of observations and minimizing variance across the ensembles; and
selectively output a prediction on ocean conditions.

20. The non-transitory computer readable medium as set forth in claim 19, wherein the analysis state is used as an initial condition to perform forecasting or generate the ensembles for a next cycle.
